(19) United States
(12) Patent Application Publication
(10) Pub. No.: US 2016/0219884 A1
(43) Pub. Date: Aug. 4, 2016

(54) CERAMIC ARTICLE AND A METHOD FOR PRODUCTION THEREOF

(71) Applicant: Duravit Aktiengesellschaft, Hornberg (DE)

(72) Inventors: Thomas STAMMEL, Hornberg (DE); Sebastian SANDER, Waldkirch (DE); Damien GENDRONNEAU, Hausach (DE)

(21) Appl. No.: 15/013,512

(22) Filed: Feb. 2, 2016

(30) Foreign Application Priority Data
Feb. 4, 2015 (DE) 10 2015 101 609.5

(51) Int. Cl. A01N 59/16; B05D 1/02; B05D 1/18

(52) U.S. Cl. CPC A01N 59/16; B05D 1/18; B05D 1/02

(57) ABSTRACT

A ceramic article, in particular a ceramic sanitation, kitchen or laboratory article, wherein it has a ceramic main body which at least portionwise has an antibacterial surface and/or an antibacterial surface coating containing a weight fraction of more than 35 weight percent of zinc oxide.

### CROSS-REFERENCE TO RELATED APPLICATIONS

The present application claims priority of DE 10 2015 101 609.5, filed Feb. 4, 2015, the priority of this application is hereby claimed and this application is incorporated herein by reference.

### BACKGROUND OF THE INVENTION

This invention relates to a ceramic article, in particular to a ceramic sanitation article, to a ceramic kitchen article or to a ceramic laboratory article, and to a method for production thereof.

Ceramic articles are articles made of ceramic materials or comprising ceramic materials as essential constituents, and are well known. The familiar fields of application and/or use for such ceramic articles include in particular the sanitary, kitchen and laboratory sectors.

Particularly in the aforementioned areas of application or use, antibacterial properties on the part of the particular ceramic articles to be employed therein may be advantageous or even, say for compliance with certain standard specifications, mandatory.

The antibacterial effect of previously known ceramic articles having antibacterial properties is occasionally inadequate and thus in need of improvement.

Thereby, it was found out that for some diseases no satisfying result is obtained. Here, especially the treatment of migraine is concerned which is sometimes not efficiently treatable when using conventional stimulation devices.

### SUMMARY OF THE INVENTION

The problem addressed by the present invention in relation thereto is that of devising an improved ceramic article, particularly with regard to its antibacterial properties.

The problem is solved by a ceramic article of the type referred to incipitly, said ceramic article having a ceramic main body which at least portionwise has an antibacterial surface and/or an antibacterial surface coating containing a weight fraction of more than 35 weight percent of zinc oxide (ZnO).

The ceramic article described herein comprises a ceramic main body. The ceramic main body is typically sufficient to define the geometry of the ceramic article that in turn will dictate the or generally a field of application and/or use for the ceramic article.

Since the ceramic article described herein comprises in particular a ceramic sanitation, kitchen or laboratory article, the geometry of the ceramic main body may, for example, represent that of a toilet bowl, a wash-basin and/or wash-stand, a kitchen sink and/or sink unit, or a laboratory sink and/or laboratory bench.

It will be appreciated that the above, purely exemplary list does leave room for other geometries and thus fields of application and/or use. The ceramic article described herein may accordingly also be for example a glazed or unglazed tile, in particular for outdoors, a glazed or unglazed bricktile, in particular a rooftile, a crockery component, i.e., e.g., a cup, a plate, etc., or a jewelry component, in particular a watch, i.e., in particular watch main body displaying the time of day, or the or one element of a watch strap. In the aforementioned ceramic articles, the weight fraction of zinc oxide may optionally also be below 35 weight percent.

The ceramic main body has an antibacterial surface and/or an antibacterial surface coating at least portionwise, i.e., fully if desired, and/or is provided with such at least portionwise, i.e., fully if desired.

An antibacterial surface is a portionwise, i.e., surficially, acting antibacterial effect of the ceramic main body. The ceramic material forming the ceramic main body here thus has antibacterial properties at least portionwise in the region of the surface at least. The antibacterial properties of the ceramic main body are the result of the latter being formed of an antibacterial material or at least comprising an antibacterial material. The realization of antibacterial properties here does not necessarily require the application of an additional antibacterial coating on the ceramic main body. It will be appreciated that such an antibacterial coating may additionally be applied on the ceramic main body at least portionwise.

An antibacterial surface coating is an at least portionwise coating of the ceramic main body with an antibacterially acting surface coating. The ceramic material forming the ceramic main body is thus at least portionwise coated with an antibacterially acting surface coating in the region of the surface, and/or such an antibacterially acting surface coating is at least portionwise applied to the ceramic main body in the region of the surface, which, as will be mentioned hereinbelow, may have already have a base coating applied to it previously. The ceramic main body here is thus not necessarily formed of an antibacterial material or comprises at least an antibacterial material. The antibacterial properties of the antibacterial surface coating are the result of the latter being formed of an antibacterial material or at least comprising an antibacterial material.

Both such an antibacterial surface and such an antibacterial surface coating contain a weight fraction of more than 35 weight percent of zinc oxide, i.e., in particular at least 36 weight percent of zinc oxide, as antibacterial constituent. When the antibacterial surface or the antibacterial surface coating includes further constituents, the weight fraction of zinc oxide in the overall composition is accordingly more than 35 weight percent, in particular at least 36 weight percent, of zinc oxide. In total, all the constituents of the antibacterial surface or of the antibacterial surface coating do of course add up to an overall composition of 100 weight percent.

Tests carried out in connection with the genesis of the present invention showed that specifically weight fractions of more than 35 weight percent of zinc oxide ensure an outstanding antibacterial effect unattainable with weight fractions of up to 35 weight percent of zinc oxide.

Any zinc oxide weight fraction in the fraction range from more than 35 weight percent to 100 weight percent of zinc oxide may be contemplated. Hence particularly zinc oxide weight fractions of 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 and 100 weight percent and intermediate values between the recited weight fractions are possible. In principle, the antibacterial effect is increasable by increasing the weight fraction of zinc oxide.

As mentioned, the constituents of such an antibacterial surface or of such an antibacterial surface coating all always sum to an overall composition of 100 weight percent. An exception is of course the case of an antibacterial surface or of an antibacterial surface coating consisting completely, i.e., 100%, and thus of purely zinc oxide.

The weight fraction of more than 35 weight percent of zinc oxide is similarly representable in the Seger formula which, in relation to ceramic coatings and/or glazes, is known to express the molar ratio of the oxides present in the coating and/or glaze. In the Seger formula, basic, amphoteric and acidic oxides of a ceramic composition are each listed in a separate group (column). The reference quantity is the molar sum of the basic oxides, which is set equal to “1”. The Seger formula permits a classification of coatings and/or glazes for certain purposes. Translated into the terms of the Seger formula, the weight fraction of more than 35 weight percent of zinc oxide corresponds to a zinc oxide fraction of more than 0.4.

A possible Seger formula is hereinbelow exemplified for firing temperatures in a temperature range between 1150° C. and 1300° C.:

| | | |
|---|---|---|
| Basic oxides | Amphoteric oxides | Acidic oxides |

| | | | | |
|---|---|---|---|---|
| 0.02-0.2 | Na₂O | 0.1-1 Al₂O₃ | 1.5-3.8 | SiO₂ |
| 0.01-0.2 | Li₂O | | | |
| 0.01-0.4 | K₂O | | | |
| 0.01-0.15 | MgO | | 0.05-0.2 | ZrO₂ |
| 0.1-0.6 | CaO | | 0.001-0.4 | SnO₂ |
| 0.05-0.2 | BaO | | 0.05-0.2 | B₂O₃ |
| 0.05-0.2 | SrO | | 0.005-0.35 | TiO₂ |
| >0.4 | ZnO | | | |

Σ = 1

A corresponding antibacterial surface coating may be formed directly on the ceramic main body and/or be directly applied to the ceramic main body. The direct application of a corresponding antibacterial surface coating may have advantages in the manufacturing process. Alternatively, a corresponding antibacterial surface coating may be formed on and/or applied to a base coating (previously) applied to and/or formed on the ceramic main body. The application of the antibacterial surface coating to a corresponding base coating may be advantageous in particular in cases in which an antibacterial surface coating cannot, for example for composition-related reasons, be readily applied to the ceramic main body in a stable manner. This issue is resolvable by “inserting” a base coating with which the antibacterial surface coating to be applied is highly compatible in chemical-physical respects. A corresponding base coating may be, for example, a standard glaze selected with an eye to the particular field of application and/or use for the ceramic article. In the exemplary case of a ceramic sanitation article, a corresponding base coating may accordingly be for example a standard sanitation glaze, for example on the basis of aluminum oxide (Al₂O₃) or silicon oxide (SiO₂).

A possible Seger formula for a base coating is exemplified hereinbelow for firing temperatures in a temperature range between 1150° C. and 1300° C.

| | | |
|---|---|---|
| Basic oxides | Amphoteric oxides | Acidic oxides |

| | | | | |
|---|---|---|---|---|
| 0.14 | Na₂O | 0.39 Al₂O₃ | 3.54 | SiO₂ |
| 0.01 | K₂O | | | |
| 0.09 | MgO | | 0.02 | B₂O₃ |
| 0.76 | CaO | | | |

Σ = 1

The layer thickness of a corresponding antibacterial surface coating may be, in particular after any firing, in a layer thickness range between 0.1 mm and 3 mm, in particular between 0.25 mm and 1.5 mm, preferably between 0.5 mm and 1 mm. Tests have shown that corresponding layer thicknesses are sufficient for a reliable antibacterial effect due to the antibacterial surface coating. It will be appreciated that exceptions are conceivable in this context, i.e., layer thicknesses may exceptionally be below 0.1 mm and/or above 3 mm. A corresponding antibacterial surface coating need not have the same layer thickness everywhere, i.e., the layer thickness of an antibacterial surface coating may vary regionwise irrespective of variations introduced by the manufacturing process.

Where, as described, it is conceivable that the antibacterial surface coating consists of purely zinc oxide, the layer thickness of the antibacterial surface coating is typically in a layer thickness range between 0.1 mm and 3 mm, in particular between 0.25 mm and 1.5 mm, preferably between 0.5 mm and 1 mm. The recited layer thickness range may have technical advantages in the manufacturing process and prevent any excessive adverse effect on the optical properties, in particular any excessive matting, of the antibacterial surface and/or of the antibacterial surface coating.

A corresponding antibacterial surface and/or a corresponding antibacterial surface coating may additionally contain silver, in particular in a weight fraction of 0.005-5 weight percent. The antibacterial effect may be precisely influenced by the admixture of silver. The silver may be admixed in metallic form. It is nevertheless also conceivable to admix a silver compound, e.g., silver carbonate (Ag₂CO₃).

A corresponding antibacterial surface and/or a corresponding antibacterial surface coating may additionally contain tin oxide (SnO₂), in particular in a weight fraction of 0.1-20 weight percent. Tin oxide is capable of acting as nucleator and thus of promoting the formation of a stable antibacterial surface coating. The surface constitution of the antibacterial surface and/or of the antibacterial surface coating may further be influenced by the admixture of tin oxide.

A corresponding antibacterial surface and/or a corresponding antibacterial surface coating may additionally contain cerium oxide (CeO₂), in particular in a weight fraction of 0.05-1 weight percent. Cerium oxide is capable of acting as nucleator and thus of promoting the formation of a stable antibacterial surface coating. The surface constitution of the antibacterial surface and/or of the antibacterial surface coating may further be influenced by the admixture of cerium oxide.

A corresponding antibacterial surface and/or a corresponding antibacterial surface coating may additionally contain titanium oxide (TiO₂), in particular in a weight fraction of 0.05-1 weight percent. Like tin oxide and cerium oxide, titanium oxide is capable of acting as nucleator and thus of promoting the formation of a stable antibacterial surface coating. The surface constitution of the antibacterial surface and/or of the antibacterial surface coating may further be influenced by the admixture of titanium oxide.

The zinc oxide present in the antibacterial surface and/or the antibacterial surface coating is typically in particulate form. The particle properties, i.e., in particular particle shape, size and distribution and/or their fineness, can be used to influence the reactivity and also the meltability of the particles and thus of the antibacterial surface coating as a whole. Comparatively high finenesses, i.e., comparatively fine particle sizes, are advantageous in this context. Accordingly, at least 3% of the overall fraction of zinc oxide may have a particle size above 45 μm for example.

The invention further provides a method of producing a ceramic article, in particular a ceramic article as described above, which has a ceramic main body which at least portionwise has an antibacterial surface and/or an antibacterial surface coating containing a weight fraction of more than 35 weight percent of zinc oxide. The process is characterized by the following essential steps:
providing a ceramic main body,
forming on the ceramic main body an antibacterial surface coating containing a weight fraction of more than 35 weight percent of zinc oxide and/or an antibacterial surface containing a weight fraction of more than 35 weight percent of zinc oxide, to produce the ceramic article.

Following a first step of providing a ceramic main body, a subsequent second step comprises forming an antibacterial surface containing a weight fraction of more than 35 weight percent of zinc oxide, in particular at least 36 weight percent of zinc oxide, and/or an antibacterial surface coating containing a weight fraction of more than 35 weight percent of zinc oxide, in particular at least 36 weight percent of zinc oxide. The second step thus comprises in general the performance of at least one measure to form an antibacterial surface and/or an antibacterial surface coating. As will become apparent hereinbelow, the formation of the antibacterial surface and/or of the antibacterial surface coating typically comprises at least one firing of the ceramic main body.

All the observations named in connection with the ceramic article hold similarly for the method. Conversely, all the observations made in connection with the method hold similarly for the ceramic article to be produced and/or obtained.

An unfired ceramic main body (ceramic body) may be used in the context of the method. The step of forming the antibacterial surface and/or the antibacterial surface coating may accordingly be carried out on an unfired ceramic main body.

More particularly, the method may utilize an unfired ceramic main body whereto a base coating is or has previously been applied portionwise at least. A corresponding antibacterial surface coating can thus be applied to a corresponding base coating. The prior at least portionwise application of a base coating may similarly be effected in the context of the method described herein. A specific example is the use of an unfired ceramic main body whereto a base coating having a layer thickness in a layer thickness range between 0.5 mm and 3 mm, in particular 1 mm and 2 mm, is or has been applied portionwise at least.

The antibacterial surface coating may further be applied to the base coating in a layer thickness between 0.1 mm and 3 mm, in particular between 0.25 mm and 1.5 mm, preferably between 0.5 mm and 1 mm. Optionally, the antibacterial surface coating may also be applied to the base coating in a layer thickness (distinctly) above 3 mm, so that the aforementioned layer thickness ranges only come about after firing.

As mentioned, the formation of the antibacterial surface and/or of the antibacterial surface coating typically comprises at least one firing. Specifically, to form the antibacterial surface and/or the antibacterial surface coating, a firing may be carried out with a firing temperature in a temperature range between 1100° C. and 1350° C., in particular 1130° C. and 1280° C. The firing temperature, the firing time, etc. can be used to influence the specific composition of the antibacterial surface and/or of the antibacterial surface coating. The recited temperature range between 1100° C. and 1350° C., in particular between 1130° C. and 1280° C., generally ensures a reliable formation of an antibacterial surface and/or of an antibacterial surface coating. The recited temperature range enables sufficient melting of any coating material without the latter becoming excessively liquid, which would complicate the application of an antibacterial surface coating.

As an alternative to the formation of a corresponding antibacterial surface and/or of a corresponding antibacterial surface coating on an unfired ceramic main body, the formation of a corresponding antibacterial surface and/or of a corresponding antibacterial surface coating may also be carried out on a prefired ceramic main body (ceramic body). A prefired ceramic main body may thus also be used in the context of the method.

In this case, a corresponding antibacterial surface coating may be applied to the prefired ceramic main body in a layer thickness between 0.1 mm and 3 mm, in particular between 0.25 mm and 1.5 mm, preferably between 0.5 mm and 1 mm. Optionally, the antibacterial surface coating may here also be applied in a layer thickness (distinctly) above 3 mm, so that the aforementioned layer thickness ranges only result after a (second) firing.

To form the antibacterial surface coating, a firing may be carried out here at a firing temperature in a temperature range between 650° C. and 1350° C., in particular between 700° C. and 1280° C. Accordingly, lower firing temperatures, in particular below 1100° C., are optionally possible by comparison. It will be appreciated that again the firing temperature, firing time, etc. can be used to influence the specific composition of the antibacterial surface coating.

The antibacterial surface and/or the antibacterial surface coating may be formed by additional admixture of silver, in particular at a weight fraction of 0.005-5 weight percent of silver. The silver is typically admixed in metallic form. Nonetheless, the admixture of a silver compound, e.g., silver carbonate, is also conceivable.

The antibacterial surface and/or the antibacterial surface coating may further be formed by additional admixture of tin oxide, in particular at a weight fraction of 0.1-20 weight percent of tin oxide.

Alternatively or additionally, the antibacterial surface and/or the antibacterial surface coating may be formed by additional admixture of cerium oxide and/or titanium oxide, in particular at a weight fraction of 0.05-1 weight percent of cerium oxide and/or at a weight fraction of 0.05-1 weight percent of titanium oxide.

As repeatedly mentioned in connection with the ceramic article, a corresponding antibacterial surface and/or a corresponding antibacterial surface coating may also be formed completely, i.e., at 100%, and thus of purely zinc oxide.

The method may utilize particulate zinc oxide where at least 3% of the overall fraction of zinc oxide used has a particle size above 45 μm.

The step of applying any antibacterial surface coating may be carried out using a printing, in particular screen printing, casting, spraying, atomizing, spread or dip coating process or a combination of two or more of the recited coating processes. Particularly in the conceivable case described of an antibacterial surface coating consisting completely, i.e., 100%, and thus of purely zinc oxide, a sprayed application may be advantageous for technical manufacturing and thus commercial reasons.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIGS. 1 and 2 each show an in-principle depiction of a detail of a ceramic article according to an exemplary embodiment of the invention; and

FIG. 3 shows a diagram to illustrate the antibacterial effect of antibacterial surface coatings of a ceramic article according to an exemplary embodiment of the invention.

### DETAILED DESCRIPTION OF THE INVENTION

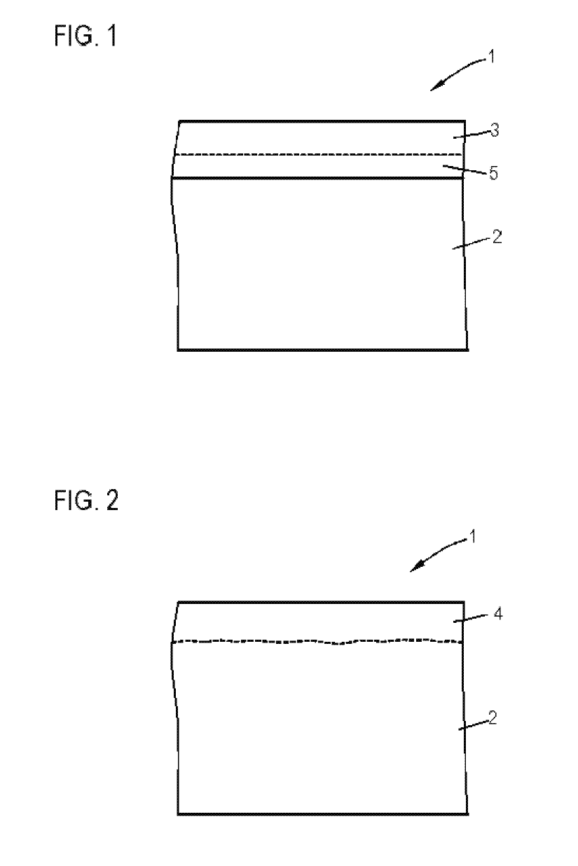

FIGS. 1 and 2 each show an in-principle depiction of a detail of a ceramic article 1 according to an exemplary embodiment of the invention in a sectional view.

The ceramic article 1 comprises a ceramic main body 2. The ceramic article 1 shown in the illustrative embodiments shown in the figures may be, for example, a ceramic sanitation, kitchen or laboratory article, i.e., e.g., a toilet bowl, a wash-basin and/or wash-stand, a kitchen sink and/or sink unit or a laboratory sink and/or laboratory bench.

The ceramic main body 2 shown in the exemplary embodiment as per FIG. 1 has an antibacterial surface coating 3 and/or is provided with such, while the ceramic main body shown in the exemplary embodiment as per FIG. 2 has an antibacterial surface 4 and/or is provided with such.

An antibacterial surface coating (cf. FIG. 1) is an at least portionwise coating of the ceramic main body 2 with an antibacterially acting surface coating 3. The ceramic material forming the ceramic main body 2 is thus at least portionwise coated with an antibacterially acting surface coating 3 in the region of the surface, and/or such an antibacterially acting surface coating 3 is at least portionwise applied to the ceramic main body 2 in the region of the surface. The ceramic main body 2 here is thus not necessarily formed of an antibacterial material or comprises at least an antibacterial material. The antibacterial properties of the antibacterial surface coating 3 are the result of the latter being formed of an antibacterial material or at least comprising an antibacterial material.

An antibacterial surface 4 (cf. FIG. 2) is a portionwise, i.e., surficially, acting antibacterial effect of the ceramic main body 2. The ceramic material forming the ceramic main body 2 here thus has antibacterial properties at least portionwise in the region of the surface at least. The antibacterial properties of the ceramic main body 2 are the result of the latter being formed of an antibacterial material or at least comprising an antibacterial material.

Both such an antibacterial surface 4 shown in FIG. 2 and such an antibacterial surface coating 3 shown in FIG. 1 contain a weight fraction of more than 35 weight percent of zinc oxide (ZnO), i.e., in particular at least 36 weight percent of zinc oxide, as antibacterial constituent. When the antibacterial surface 4 or the antibacterial surface coating 3 includes further constituents, the weight fraction of zinc oxide in the overall composition is accordingly more than 35 weight percent, in particular at least 36 weight percent, of zinc oxide. In total, all the constituents of the antibacterial surface 4 or of the antibacterial surface coating 3 add up to an overall composition of 100 weight percent. The exception is the case of an antibacterial surface coating 3 and/or of an antibacterial surface 4 consisting completely, i.e., 100%, and thus of purely zinc oxide.

As the tests described hereinbelow show, weight fractions of more than 35 weight percent of zinc oxide ensure an outstanding antibacterial effect. This is unattainable with weight fractions of up to 35 weight percent of zinc oxide.

The weight fraction of more than 35 weight percent of zinc oxide is similarly representable in the Seger formula which, in relation to ceramic coatings and/or glazes, is known to express the molar ratio of the oxides present in the coating and/or glaze. Translated into the terms of the Seger formula, the weight fraction of more than 35 weight percent of zinc oxide corresponds to a zinc oxide fraction of more than 0.9.

A possible Seger formula is hereinabove exemplified for firing temperatures in a temperature range between 1150° C. and 1300° C.

A corresponding antibacterial surface coating 3 may be formed directly on the ceramic main body 2 and/or be directly applied to the ceramic main body 2. As indicated in FIG. 1 by the region schematically separated off by the broken line, the antibacterial surface coating 3 may be formed on and/or applied to a base coating 5 (previously) applied to and/or formed on the ceramic main body 2. A corresponding base coating 5 may be, for example, a standard glaze selected with an eye to the particular field of application and/or use for the ceramic article 1. In the exemplary case of a ceramic sanitation article, a corresponding base coating 5 may accordingly be for example a standard sanitation glaze, for example on the basis of aluminum oxide (Al₂O₃) or silicon oxide (SiO₂).

The layer thickness of a corresponding antibacterial surface coating 3 may be, in particular after any firing, in a layer thickness range between 0.1 mm and 3 mm, in particular between 0.25 mm and 1.5 mm, preferably between 0.5 mm and 1 mm. The antibacterial surface coating 3 need not have the same layer thickness everywhere, i.e., the layer thickness of an antibacterial surface coating 3 may vary regionwise irrespective of variations introduced by the manufacturing process.

When the antibacterial surface coating 3 consists of purely zinc oxide, the layer thickness of the antibacterial surface coating 3 is typically in a layer thickness range between 0.1 mm and 3 mm, in particular between 0.25 mm and 1.5 mm, preferably between 0.5 mm and 1 mm.

The antibacterial surface coating 3 may additionally contain silver, in particular in a weight fraction of 0.005-5 weight percent. The same holds for the antibacterial surface 4. The antibacterial effect may be precisely influenced by the admixture of silver. The silver may be admixed in metallic form. It is nevertheless also conceivable to admix a silver compound, e.g., silver carbonate (Ag₂CO₃).

The antibacterial surface coating 3 may additionally contain tin oxide (SnO₂), in particular in a weight fraction of 0.1-20 weight percent, alternatively to or in addition to the silver content. The same holds again for the antibacterial surface 4. Tin oxide is capable of acting as nucleator and thus of promoting the formation of a stable antibacterial surface coating 3. The surface constitution of the antibacterial surface 4 and/or of the antibacterial surface coating 3 may further be influenced by the admixture of tin oxide.

The antibacterial surface coating 3 may additionally contain cerium oxide (CeO₂), in particular in a weight fraction of 0.05-1 weight percent, alternatively to or additionally to the silver content and the tin oxide content. The same again holds for the antibacterial surface 4. Like tin oxide, cerium oxide is also capable of acting as a nucleator and thus of promoting the formation of a stable antibacterial surface coating 3. The surface constitution of the antibacterial surface 4 and/or of the antibacterial surface coating 3 may further be influenced by the admixture of cerium oxide.

The antibacterial surface coating 3 may further additionally contain titanium oxide (TiO₂), in particular in a weight fraction of 0.05-1 weight percent, alternatively or additionally to the silver content, the tin oxide content and the cerium oxide content. The same again holds for the antibacterial surface 4. Like tin oxide and cerium oxide, titanium oxide is also capable of acting as a nucleator and thus of promoting the formation of a stable antibacterial surface coating 3. The surface constitution of the antibacterial surface 4 and/or of the antibacterial surface coating 3 may further be influenced by the admixture of titanium oxide.

The zinc oxide present in the antibacterial surface 4 and/or the antibacterial surface coating 3 is typically in particulate form. The particle properties, i.e., in particular particle shape, size and distribution and/or their fineness, can be used to influence the reactivity and also the meltability of the particles and thus of the antibacterial surface coating 3 as a whole. Comparatively high finenesses, i.e., comparatively fine particle sizes, are advantageous in this context. Accordingly, at least 3% of the overall fraction of zinc oxide may have a particle size above 45 μm for example.

A method of producing a ceramic article 1 as shown in the exemplary embodiments of FIGS. 1 and 2 is characterized by the following essential steps:
providing a ceramic main body 2,
forming on the ceramic main body 2 an antibacterial surface coating 3 containing a weight fraction of more than 35 weight percent of zinc oxide and/or an antibacterial surface 4 containing a weight fraction of more than 35 weight percent of zinc oxide, to produce the ceramic article 1.

An unfired ceramic main body 2 (ceramic body) may be used in the context of the method. More particularly, the method may utilize an unfired ceramic main body 2 whereto a base coating 5 is or has previously been applied portionwise at least. The prior at least portionwise application of a base coating 5 may similarly be effected in the context of the method described herein. A specific example is the use of an unfired ceramic main body 2 whereto a base coating 5 having a layer thickness in a layer thickness range between 0.5 mm and 3 mm, in particular 1 mm and 2 mm, is or has been applied portionwise at least.

The antibacterial surface coating 3 may further be applied to the base coating 5 in a layer thickness between 0.1 mm and 3 mm, in particular between 0.25 mm and 1.5 mm, preferably between 0.5 mm and 1 mm. Optionally, the antibacterial surface coating 3 may also be applied to the base coating 5 in a layer thickness (distinctly) above 3 mm, so that the aforementioned layer thickness ranges only come about after firing.

To form the antibacterial surface 4 and/or the antibacterial surface coating 3, a firing may be carried out with a firing temperature in a temperature range between 1100° C. and 1350° C., in particular 1130° C. and 1280° C. The firing temperature, the firing time, etc. can be used to influence the specific composition of the antibacterial surface 4 and/or of the antibacterial surface coating 3. The recited temperature range enables sufficient melting of any coating material without the latter becoming excessively liquid, which would complicate the application of an antibacterial surface coating 3.

As an alternative to the formation of a corresponding antibacterial surface 4 and/or of a corresponding antibacterial surface coating 3 on an unfired ceramic main body 2, the formation of a corresponding antibacterial surface 4 and/or of a corresponding antibacterial surface coating 3 may also be carried out on a prefired ceramic main body 2 (ceramic body). In this case, a corresponding antibacterial surface coating 3 may be applied to the prefired ceramic main body 2 in a layer thickness between 0.1 mm and 3 mm, in particular between 0.25 mm and 1.5 mm, preferably between 0.5 mm and 1 mm. Optionally, the antibacterial surface coating 3 may here also be applied in a layer thickness (distinctly) above 3 mm, so that the aforementioned layer thickness ranges only result after a (second) firing.

To form the antibacterial surface coating 3, a firing may be carried out here at a firing temperature in a temperature range between 650° C. and 1350° C., in particular between 700° C. and 1280° C. Accordingly, lower firing temperatures, in particular below 1100° C., are optionally possible by comparison. It will be appreciated that again the firing temperature, firing time, etc. can be used to influence the specific composition of the antibacterial surface coating 3.

The method may be used to form an antibacterial surface coating 3 and/or an antibacterial surface 4 by additional admixture of silver and/or tin oxide and/or cerium oxide and/or titanium oxide. Particular weight fractions for particular additional constituents are recited hereinabove.

In all cases, an antibacterial surface coating 3 may be applied for example using a printing, in particular screen printing, casting, spraying, atomizing, spread or dip coating process or a combination of two or more of the recited coating processes.

The special antibacterial effect of corresponding antibacterial surface coatings 3—the same holds for corresponding antibacterial surfaces 4—was confirmed in tests. The results of these tests are more particularly described hereinbelow.

In one series of tests, ceramic articles—specifically ceramic tiles (test surfaces)—having a corresponding antibacterial surface coating 3 were tested for their antibacterial properties with regard to Escherichia coli (NCTC 10538) as test germ/organism. The tests were carried out in accordance with the Japanese industrial standard “JIS Z 2801:2010 —Antimicrobial products—Test for antimicrobial activity and efficacy” and the standard “BS ISO 22196:2007 —Plastics—Measurement of antibacterial activity on plastics surfaces”.

Results of the tests of this series of tests are shown versus an included control in the table which follows. Four tiles were tested per run. The control surfaces used were glass surfaces without antibacterial surface coating 3. The test for an antibacterial effect was carried out at a temperature of 37° C. using a treatment time of 24 hours.

| | Test surface | Control | | Control uncoated |
|---|---|---|---|---|
| | 24 h mean | 24 h mean | RF control | (=initial conc.) |
| | [log₁₀ steps] | [log₁₀ steps] | test surface | [log₁₀ steps] |
| run 1 | 2.29 | −0.97 | 3.26 | 2.47 × 10⁵ |
| run 2 | 2.08 | −0.94 | 3.02 | 2.47 × 10⁵ |

As is apparent from the table, the Escherichia coli test organisms were reduced in both runs by 2.29 and 2.08 log₁₀ steps during incubation on the antibacterially coated test surfaces. Having regard to the growth of the test organisms on the control surfaces without antibacterial surface coating 3 (0.97 and 0.94 log₁₀ steps), therefore, the effective reduction of the test organisms on the antibacterially coated test surfaces was 3.26 log₁₀ steps in run 1 and 3.02 log₁₀ steps in run 2. The antibacterial surface coating 3 can thus be attested a reliable antibacterial efficacy. It must be borne in mind here that the appellation “antibacterial effect” pursuant to JIS Z 2801:2010 requires a reduction in the test organisms by not less than two log₁₀ steps.

In a further series of tests, ceramic articles—ceramic tiles again here—having corresponding antibacterial surface coatings 3 of differing composition were tested for their antibacterial properties with regard to Escherichia coli (NCTC 10538) as test germ/organism. The tests were similarly carried out in accordance with the Japanese industrial standard “JIS Z 2801:2010 —Antimicrobial products—Test for antimicrobial activity and efficacy”.

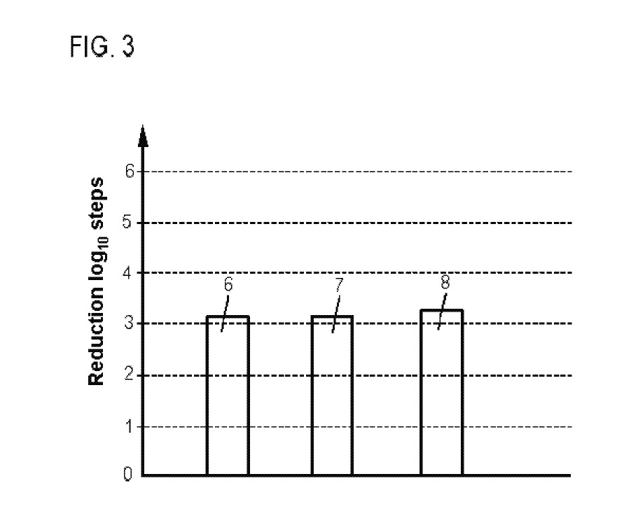

The results of this series of tests are depicted in the diagram shown in FIG. 3.

Bar 6 represents an antibacterial surface coating 3 having a composition of dolomite at about 2.60 weight percent, calcium carbonate at about 10.19, chamotte at about 12.15 weight percent, frit at about 3.99 weight percent, kaolin at about 5.21 weight percent, quartz flour at about 28.63 weight percent, zirconium silicate at about 9.11 weight percent, feldspar at about 10.54 weight percent, tin oxide at about 0.87 weight percent and zinc oxide at about 35.50 weight percent. The antibacterial surface coating 3 for test purposes further contains a fraction of water, size and a superplasticizing agent. Firing was carried out at a temperature of 1282° C.

Bar 7 represents an antibacterial surface coating 3 having a composition of dolomite at about 2.60 weight percent, calcium carbonate at about 9.11 weight percent, chamotte at about 12.15 weight percent, frit at about 3.99 weight percent, kaolin at about 5.21 weight percent, quartz flour at about 30.80 weight percent, zirconium silicate at about 9.11 weight percent, feldspar at about 9.46 weight percent, tin oxide at about 0.87 weight percent and zinc oxide at about 35.50 weight percent. The antibacterial surface coating 3 for test purposes further contains a fraction of water, size and a superplasticizing agent. Firing was carried out at a temperature of 1280° C.

Bar 8 represents an antibacterial surface coating 3 having a composition of dolomite at about 2.60 weight percent, calcium carbonate at about 9.11 weight percent, chamotte at about 12.15 weight percent, frit at about 3.99 weight percent, kaolin at about 5.21 weight percent, quartz flour at about 30.80 weight percent, zirconium silicate at about 9.11 weight percent, feldspar at about 9.46 weight percent, tin oxide at about 0.87 weight percent and zinc oxide at about 35.50 weight percent. The antibacterial surface coating 3 for test purposes further contains a fraction of water, size and a superplasticizing agent. Firing was carried out at a temperature of 1280° C.

The results depicted in FIG. 3 suggest there is at any rate a verifiable antibacterial effect of three log₁₀ steps.

While specific embodiments of the invention have been shown and described in detail to illustrate the inventive principles, it will be understood that the invention may be embodied otherwise without departing from such principles.

We claim:

1. A ceramic article, in particular a ceramic sanitation, kitchen or laboratory article, comprising a ceramic main body which at least portionwise has an antibacterial surface and/or an antibacterial surface coating containing a weight fraction of more than 35 weight percent of zinc oxide.

2. The ceramic article according to claim 1, wherein the antibacterial surface coating is applied directly to the ceramic main body or to a base coating at least portionwise applied to the ceramic main body.

3. The ceramic article according to claim 1, wherein the layer thickness of the antibacterial surface coating is in a layer thickness range between 0.1 mm and 3 mm, in particular between 0.25 mm and 1.5 mm, preferably between 0.5 mm and 1 mm.

4. The ceramic article according to claim 1, wherein the antibacterial surface and/or the antibacterial surface coating additionally contains a weight fraction of 0.005-5 weight percent of silver.

5. The ceramic article according to claim 1, wherein the antibacterial surface and/or the antibacterial surface coating additionally contains a weight fraction of 0.1-20 weight percent of tin oxide.

6. The ceramic article according to claim 1, wherein the antibacterial surface and/or the antibacterial surface coating additionally contains a weight fraction of 0.05-1 weight percent of cerium oxide.

7. The ceramic article according to claim 1, wherein the antibacterial surface and/or the antibacterial surface coating additionally contains a weight fraction of 0.05-1 weight percent of titanium oxide.

8. The ceramic article according to claim 1, wherein the antibacterial surface and/or the antibacterial surface coating consists of purely zinc oxide.

9. The ceramic article according to claim 8, wherein the layer thickness of the antibacterial surface coating is in a layer thickness range between 0.1 mm and 3 mm, in particular between 0.25 mm and 1.5 mm, preferably between 0.5 mm and 1 mm.

10. The ceramic article according to claim 1, wherein the zinc oxide is in a particulate form where at least 3% of the overall fraction of zinc oxide has a particle size above 45 μm.

11. A method of producing a ceramic article, in particular a ceramic article according to claim 1, which has a ceramic main body which at least portionwise has an antibacterial surface and/or an antibacterial surface coating containing a weight fraction of more than 35 weight percent of zinc oxide, comprising the steps of:
providing a ceramic main body,
forming on the ceramic main body an antibacterial surface coating containing a weight fraction of more than 35 weight percent of zinc oxide and/or an antibacterial surface containing a weight fraction of more than 35 weight percent of zinc oxide, to produce the ceramic article.

12. The method according to claim 11, wherein an unfired ceramic main body is used and the forming of the antibacterial surface and/or of the antibacterial surface coating is carried out on the unfired ceramic main body.

13. The method according to claim 12, wherein an unfired ceramic main body is used, a base coating is applied thereto at least portionwise, and the antibacterial surface coating is applied to the base coating.

14. The method according to claim 13, wherein an unfired ceramic main body is used and a base coating is applied thereto at least portionwise in a layer thickness between 0.5 mm and 3 mm, in particular 1 mm and 2 mm.

15. The method according to claim 13, wherein the antibacterial surface coating is applied to the base coating in a layer thickness between 0.1 mm and 3 mm, in particular between 0.25 mm and 1.5 mm, preferably between 0.5 mm and 1 mm.

16. The method according to claim 12, wherein a firing to form the antibacterial surface and/or the antibacterial surface coating is carried out at a firing temperature in a temperature range between 1100° C. and 1350° C., in particular between 1130° C. and 1280° C.

17. The method according to claim 11, wherein a prefired ceramic main body is used and the step of forming the antibacterial surface and/or the antibacterial surface coating is carried out on the prefired ceramic main body.

18. The method according to claim 17, wherein the antibacterial surface coating is applied to the prefired ceramic main body in a layer thickness between 0.1 mm and 3 mm, in particular between 0.25 mm and 1.5 mm, preferably between 0.5 mm and 1 mm.

19. The method according to claim 17, wherein a firing to form the antibacterial surface and/or the antibacterial surface coating is carried out at a firing temperature in a temperature range between 650° C. and 1350° C., in particular between 700° C. and 1280° C.

20. The method according to claim 11, wherein the step of applying the antibacterial surface coating is carried out using a printing, in particular screen printing, casting, spraying, atomizing, spread or dip coating process or a combination of two or more of the recited coating processes.

21. The method according to claim 11, wherein the antibacterial surface and/or the antibacterial surface coating is additionally formed by admixture of silver in a weight fraction of 0.005-5 weight percent of silver.

22. The method according to claim 11, wherein the antibacterial surface and/or the antibacterial surface coating is additionally formed by admixture of tin oxide in a weight fraction of 0.1-20 weight percent of tin oxide.

23. The method according to claim 11, wherein the antibacterial surface and/or the antibacterial surface coating is additionally formed by admixture of cerium oxide in a weight fraction of 0.05-1 weight percent of cerium oxide.

24. The method according to claim 11, wherein the antibacterial surface and/or the antibacterial surface coating is additionally formed by admixture of titanium oxide in a weight fraction of 0.05-1 weight percent of titanium oxide.

25. The method according to claim 11, wherein the antibacterial surface and/or the antibacterial surface coating is formed of purely zinc oxide.

26. The method according to claim 11, wherein particulate zinc oxide where at least 3% of the overall fraction of zinc oxide used has a particle size above 45 μm is used.
